(19) United States
(12) Patent Application Publication
(10) Pub. No.: US 2013/0149626 A1
(43) Pub. Date: Jun. 13, 2013

(54) SYSTEM AND METHOD FOR DEVICE POWER MANAGEMENT

(71) Applicant: Ardica Technologies, Inc., San Francisco, CA (US)

(72) Inventors: Daniel Braithwaite, San Francisco, CA (US); Tibor Fabian, Mountain View, CA (US); Andrew Philip Gust Peterson, San Francisco, CA (US); Courtney Aline Helland, San Francisco, CA (US); Timothy Prowten, San Jose, CA (US)

(73) Assignee: Ardica Technologies, Inc., San Francisco, CA (US)

(21) Appl. No.: 13/710,130

(22) Filed: Dec. 10, 2012

Related U.S. Application Data
(60) Provisional application No. 61/569,126, filed on Dec. 9, 2011.

(51) Int. Cl. H01M 8/04

(52) U.S. Cl. CPC H01M 8/04089
USPC 429/444

(57) ABSTRACT

A method for controlling fuel cartridge supply for a device powered by a fuel cell system, the fuel cell system including a fuel cell stack that converts fuel from the fuel cartridge into electrical power, the method including receiving operation data from each of a plurality of devices at a first time period, calculating a future fuel cartridge demand from the operation data, the future fuel cartridge demand associated with a second time period after the first time period, calculating a target fuel cartridge manufacturing volume from the future hydrogen cartridge demand, and sending the target fuel cartridge manufacturing volume to a manufacturing facility.

### CROSS REFERENCE TO RELATED APPLICATIONS

This application claims benefit of U.S. Provisional Application No. 61/569,126 filed 9 Dec. 2011, which is incorporated herein in its entirety by this reference.

This application is related to U.S. application Ser. No. 12/868,640 filed 25 Aug. 2010, which is incorporated herein in its entirety by this reference.

### TECHNICAL FIELD

This invention relates generally to the fuel cell field, and more specifically to a new and useful system and method for device power management in the fuel cell field.

### BACKGROUND

Fuel cell systems provide an appealing alternative to fossil fuels due to the renewable nature of the fuel and the low carbon footprint of energy production. Fuel cell systems typically include a fuel cell arrangement, which converts a fuel into electricity, and a fuel supply, which supplies fuel to the fuel cell arrangement. With the increased use of portable consumer devices, portability is a desirable feature in energy sources. However, to enable portability of the fuel cell system, fuel supplies must be limited to a portable size, such as to the size of a cartridge. This requirement limits the amount of fuel that can be stored within fuel supply, which, in turn, limits the amount of fuel that can be produced from each cartridge.

Many issues arise from this limitation, such as the need to replenish a user's cartridge supply with replacement cartridges. This requires the user to be cognizant of their cartridge supply levels, and can lead to inconveniences when the user neglects to track and replenish the cartridge supply. Furthermore, the fuel can have a limited shelf life (e.g. the fuel degrades over time); this, compounded with the small volume of fuel in the cartridge, can lead to the fuel in some cartridges being completely degraded by the time a user purchases or decides to utilize the cartridge, leading to unhappy customers and possible loss in suppliers' profits (e.g. due to recall).

Thus, it is desirable for customers to have a substantially automatic cartridge refilling system. It is also desirable for cartridge suppliers to have access to updated, dynamic information about the market such that they can adjust cartridge production and distribution to reduce supply risks, such as over- or under-production.

Thus, there is a need in the fuel cell field to create a new and useful method of device power management.

### BRIEF DESCRIPTION OF THE FIGURES

FIG. 1 is a schematic representation of a method of device power management.

FIG. 2 is schematic representation of an embodiment of a fuel cell system utilizing a fuel cartridge.

FIG. 3 is a schematic representation of an embodiment of the method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

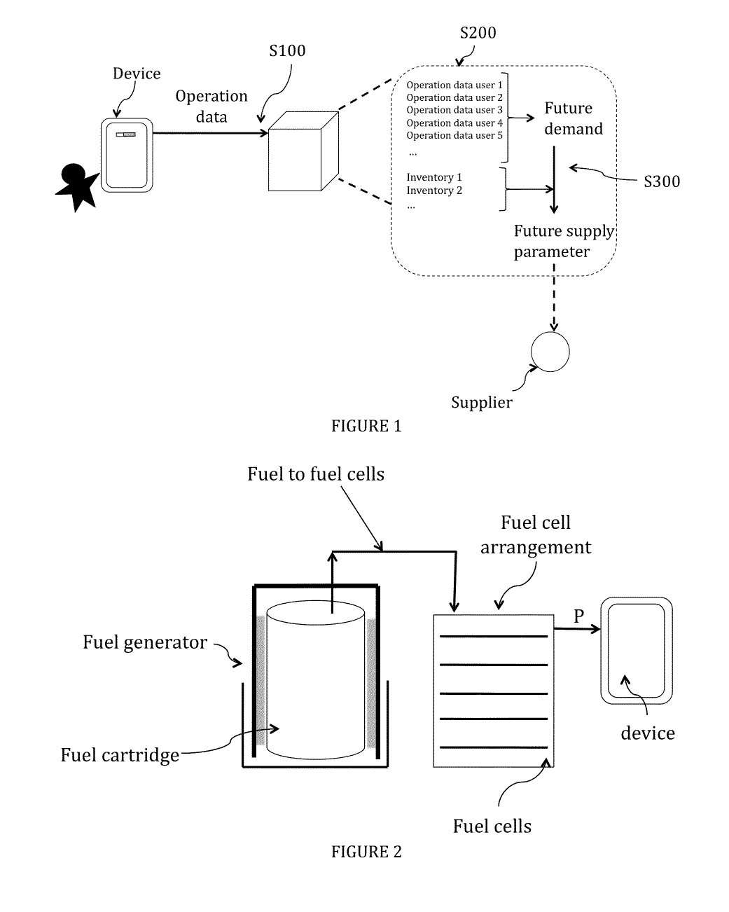

As shown in FIG. 1, a method of device power management includes receiving operation data from a device at a first time period S100, calculating a future demand parameter from the operation data S200, and determining a supply parameter based on the future demand parameter S300. This method is preferably used by a fuel supplier to dynamically manage fuel supply and production, but can additionally be used by the device to manage device power consumption and a cartridge supply of a user. The method is preferably performed by a computing system (e.g. one or more computers), and is preferably facilitated or performed by a native application on the device, but can alternatively be facilitated by a remote application on the device (e.g. through a website, HTML application, etc.).

The device is preferably a portable consumer device including a user interface, on-board memory, a processor, a data transmitter, and a data receiver. Examples of devices that can be used with the method include consumer mobile devices, such as smartphones, mobile phones, tablets, laptops, and media players, but can alternatively include vehicles or any other suitable consumer device that utilizes electric power. The transmitter and receiver preferably function to transmit and receive information, respectively. The transmitter and receiver are preferably wireless (e.g. WiFi, Bluetooth, etc.), but can alternatively be wired. The interface preferably displays notifications and input fields to the user, and is preferably capable of receiving and processing a user input (e.g. user selection, typed text, etc.). The device can additionally include a localization device (e.g. a GPS, multilateriation device, etc.), a clock, an accelerometer, a gyroscope, a humidity sensor, a light emitter, a temperature sensor, or any other suitable feature, wherein the device is preferably capable of processing and transmitting the information determined by the aforementioned features. The device can additionally include internal memory capable of storing past device operation parameters, user preferences, user interaction histories (e.g. a frequency of application access, past location searches), or any other suitable information. The device is preferably capable of accessing user accounts, such as a user calendar, a user email inbox or archive, a contact list, or any other suitable user information. The device is preferably capable of connecting to the Internet.

The device preferably draws power from a fuel cell system that accepts replaceable fuel cartridges, as shown in FIG. 2. The fuel cartridges preferably contain a fuel storage composition (e.g. alane, sodium borohydride, lithium hydride, etc.) that stores fuel in a chemically bound form (e.g. with a metallic bond, ionic bond, etc.). Alternatively, the fuel cartridges can contain compressed fuel or any other suitable fuel storage mechanism. The fuel cell system that consumes the fuel preferably includes one or more fuel cells (e.g. PEM, SOFC, etc.) that convert fuel to electric power that is preferably used to power and/or charge the device. The fuel cell system preferably includes a fuel generator that functions to react the fuel storage composition to produce a fuel, such as hydrogen, methane, propane, or any suitable fuel. The fuel cartridges are preferably substantially portable (e.g. with a length approximately 150 mm or less, or with a volume approximately 0.1-0.05 L cartridge, etc.), and can be supplied by the supplier individually or in packs of multiple cartridges. Alternatively, the fuel cartridges can be larger. The fuel cell system is preferably separate from the device, but can alternatively be incorporated within the device. The fuel cell system is preferably also substantially portable (e.g. a prism having a thickness of approximately 6 mm or less and a length and/or width of approximately 200 mM or less), but can alternatively be larger.

The device preferably determines operation data. Operation data preferably includes device data, and can additionally determine fuel cartridge and fuel cell system data. The device can additionally display the device, fuel cartridge, and/or fuel cell system data to the user. The device preferably obtains the fuel cartridge data through the fuel cell system, but can alternatively collect information directly from the cartridge, directly determine the fuel cartridge data (e.g. estimate the cartridge state based on the amount of energy supplied from the fuel cell system), receive the fuel cartridge data from a database (e.g. that is accessible through the Internet), or determine the fuel cartridge data in any other suitable manner. The device preferably determines fuel cell system data from the fuel cell system, but can alternatively directly determine fuel cell system data (e.g. determine the fuel cell system operation state based on measurements received from a temperature sensor coupled to the fuel cell system), or determine the fuel cell system data in any other suitable manner. The device preferably transmits and receives data to and from the fuel cell system through a physical connection (preferably the power transmission connection/power cable, but alternatively a separate connection such as a cable), but can alternatively communicate the data wirelessly (e.g. via Bluetooth, RF, WiFi, etc.) or through any other suitable means. Device data can include current power consumption, past power consumption (averages or distinct measurements corresponding to distinct point in time), current battery charge, battery charge duration, battery charge parameters, device identifiers, device location, current timestamp, applications in use (e.g. running on the device), downloaded applications, coupled auxiliary components, sensor data, or any other suitable device-related data. Device data can additionally include historical device data. Fuel cartridge data can include the amount of residual fuel in the cartridge, the consumed amount of fuel from the cartridge, estimated power capability from the cartridge, cartridge operation parameters, the number of cartridges left in an individual user's cartridge supply, cartridge identifiers, the fuel cartridge energy source (e.g. renewable or non-renewable), the fuel cartridge carbon footprint, or any other suitable cartridge data. The fuel cell system data includes the operation parameters of the fuel cell system, the fuel flow rate through the system, power produced by the system, time since last fuel cell system maintenance, fuel cell efficiency, fuel cell system identifiers, fuel cell age, fuel cell system error states, parameters indicative of fuel cell damage, or any other suitable fuel cell system data.

The device can additionally perform one or more actions based on the device, fuel cartridge and/or fuel cell system data. The device actions are preferably controlled by the application, but can alternatively be controlled by any other suitable means.

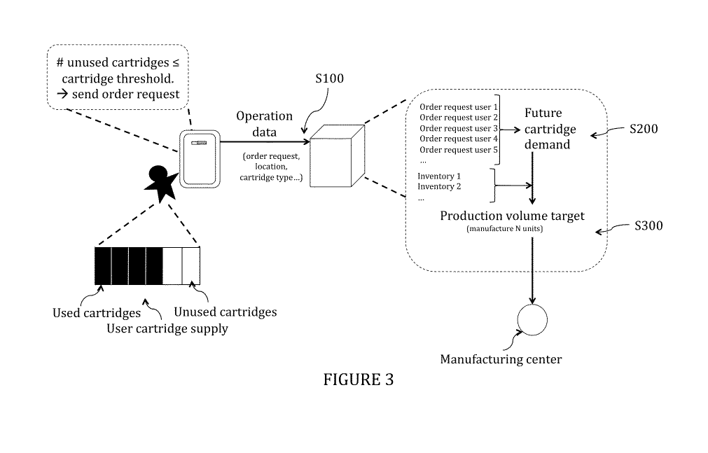

As shown in FIG. 3, the application can send an order request to a supplier or distributor based on the fuel cartridge supply data. In one variation, the device automatically sends the order for the replacement cartridges. The order information (e.g. the shipping location, number of cartridges, etc.) is preferably automatically determined from user preferences, user history (e.g. past orders input by the user), or any other suitable user information (e.g. calendar data for the user), wherein the order information can be determined by the application or by the computing system after the order request is received. In another variation, the device sends a service order to a servicing facility, wherein the service order can be an appointment and include the fault condition for which the system should be serviced.

The application can also prompt the user when the user cartridge supply is low (e.g. with a notification), and can additionally display one or more cartridge replenishment options. In one variation, the cartridge replenishment option includes placing an order for replacement cartridges. In this variation, the order information (e.g. the number of cartridges, payment information, and shipping information) is preferably stored within the device memory and auto-filled for the user, such that the order is placed upon receipt of a confirmation from the user (e.g. receipt of a “place order” selection). However, placing the order can include receiving order information from the user, wherein the order information can be received as a text entry, selection, or received in any other form. In a second variation, the cartridge replenishment option includes displaying the local cartridge supplies (e.g. stores, distribution centers, kiosks, other users, etc.). In one example of this embodiment, the device displays a “low fuel” notification along with a map of cartridge suppliers near the user's current location. In a second example, devices associated with users with a large cartridge supply (e.g. over a predetermined level) can send the user's location and cartridge information (e.g. number of cartridge available, types of cartridges, etc.) to a second user, wherein the second user preferably has a low cartridge supply.

The application can also calculate and display a parameter related to power consumption, wherein the parameter can be average power use, fuel cell system use frequency, the amount of power left in the current cartridge, the percent of power used on/off the fossil fuel power grid, the carbon footprint of the device, the user's device use habits, or any other suitable parameter. The parameter can be displayed in numeric form, as a graphical representation (e.g. as an icon), or in any other suitable form. In one variation, the device can record and send the parameter to the computing system, wherein the computing system can determine the future cartridge demand from the parameter. In another variation, the device can record and send the carbon footprint data, wherein the data can be subsequently received by a government department, wherein the user's carbon savings can be exchanged for tax credits. The device can additionally display operation data. In one example, the device can display or indicate (e.g. with a colored indicator, such as a light) that the fuel cartridge was generated from renewable energy.

The application can also determine location data, and can additionally send location data to the computing system. The location data can be the substantially instantaneous device location or a future device or user location. The location is preferably represented with a geographic indicator (e.g. a set of latitude and longitude measurements), but can alternatively be represented by a venue name, a generic name (e.g. home), or with any other suitable representation. The substantially instantaneous device location is preferably determined through the localization device, but can alternatively be determined through a user entry, by scraping online social networks for mentions of an account associated with the device (e.g. a user account) with a timestamp close to the substantially instantaneous time, or through any other suitable manner. The future location is preferably a location with which the device is predicted to be associated at a second time period later than the substantially instantaneous time. The future location can be a shipping location, a habitual location (e.g. a commonly frequented location, a non-habitual location (e.g. a vacation location, business trip location), or any other suitable location. The future location can be determined by the device or the computing system. The future location can be determined from user settings (e.g. wherein the user has specified a preferred shipping location or pickup location), from the substantially instantaneous device location (e.g. based on the location history of the user or device), from a calendar accessible by the device, from an email account accessible by the device (e.g. wherein the email account is scraped for locations associated with the second time period), from a social network account accessible by the device (e.g. from a post or an event), or determined in any other suitable manner.

The application can also send operation data to the computing system. The device preferably sends operation data periodically at a predetermined frequency, but can alternatively send operation data in response to a request received from the computing system, in response to a request received from the user, in response to an operation parameter satisfying a trigger event (e.g. when the fuel available to the device falls below a fuel threshold), or at any other suitable frequency. The sent operation data preferably includes location data, but can additionally include any of the operation data described above. The device can additionally determine (e.g. calculate, correlate, etc.), and subsequently send, an overall power requirement for the device determined from the operation data.

The application can also create a product recommendation for the device, cartridge, and/or fuel cell system. The recommendation can be a maintenance recommendation, fuel cell system recommendation, a different volume fuel cartridge, use habit recommendation, or any other suitable recommendation. In one example, the recommendation is an upgrade notification, wherein the upgrade notification allows the user to download a new version of fuel cell system software. The application can install the new software on the fuel cell system PCB.

The application can also manage the device power consumption based on the operation data. The application can manage the device power independently of the computing system or manage the power based on instructions received from the computing system. In a first variation, the application places the device in a low energy consumption mode when the fuel available to the device is below a predetermined threshold. The fuel available to the device is preferably the fuel remaining within the cartridge in use, but can additionally include the fuel remaining within cartridges located within a predetermined radius of the device (e.g. as determined through near-field identification, cartridge location tracking, etc.), fuel remaining within cartridges left within the cartridge supply of the individual user, or fuel remaining within any other accessible fuel source. The low energy consumption mode is preferably a pre-existing mode within the device, but can alternatively be a mode determined by the application, wherein the application can selectively close active applications on the device, reduce power draw of active operations on the device (e.g. reduce screen brightness), throttle the power draw of the device as a whole, or reduce device energy consumption in any other suitable manner. In a third variation, the application manages the device power consumption based on a current or forecast environmental factor, such as temperature, humidity, pressure, or any other suitable environmental parameter. In an example of this variation, the device increases power consumption, thereby increasing fuel conversion and thus, heat production from the fuel cell system, in response to low ambient temperature, such that the fuel cell system functions as a heater.

The application can also manage the fuel cell system based on the operation data. The device preferably controls fuel production to meet the device energy requirements. The device preferably passively controls fuel production to meet the substantially instantaneous device energy requirement through power draw from the fuel cell system, but can alternatively control fuel production in any suitable manner. The device can additionally actively control fuel production to meet an anticipated energy requirement (e.g. by increasing the fuel generator temperature set point to promote thermolysis of the fuel storage composition). The anticipated energy requirement can be determined from device operation history (e.g. wherein a second device operation is historically correlated to a first trigger operation), a user selection (e.g. selection to increase power, selection of a power-consuming operation), or can be determined in any other suitable manner. The device can additionally control fuel cell system functionalities, such as purges, increases in fuel cell temperature, cooling, or any other suitable functionalities.

The application can additionally receive and manage user settings. User settings can include the preferred type of fuel cartridge, the preferred number of fuel cartridges, the preferred energy source for fuel cartridge manufacture (e.g. renewable vs. non-renewable energy), the preferred fuel cartridge supply vendor, the preferred shipping location, the preferred shipping method, the preferred payment information (e.g. stored credit card information), the preferred settings for notifications, the preferred settings for indicators (e.g. remaining fuel indicators, primary fuel source indicators, etc.), preferred triggers (e.g. if the instantaneous device location is not within 50 miles of the shipping location, hold shipping), or any other suitable user setting.

The application can additionally facilitate social networking (e.g. use forums, chatting, location of other fuel cell system users, etc.) or dynamic markets (e.g. accept or submit bids on fuel cartridges). The device can also provide fuel cell system and/or cartridge education, such as methods of using the system or replacing the cartridge, education about the fuel storage composition, or any other suitable education in any suitable media form.

The supplier that utilizes this method preferably manufactures the aforementioned fuel cartridges, and can additionally and/or alternatively distribute the fuel cartridges, manufacture and/or distribute the fuel cell systems, manufacture and/or distribute the device, or service the fuel cell systems and/or device. The supplier preferably produces and/or distributes the fuel cartridges using a process with a low carbon footprint (such as the method described in U.S. application Ser. No. 12/868,640, incorporated herein in its entirety by this reference), but can produce and/or distribute the fuel cartridges in any suitable manner.

As shown in FIG. 1, receiving operation data from a device at a first time period S100 functions to receive operating data indicative of device power needs at the first time period. Operating data is preferably received from a plurality of devices during the first time period, but can alternatively be received from any suitable number of devices. The information can be used to provide insight into device and/or fuel cell system use patterns of one or more users. In subsequent steps, suppliers can use such information to adjust fuel cartridge production and distribution, and can better tailor the provided cartridges and fuel cell systems to the users' needs.

The operating data is preferably received by the cartridge manufacturer, but can be received by a cartridge distributor or a fuel cell system manufacturer/designer as well. As shown in FIG. 3, a computing system remote from the user device (e.g. a database, server, computer, mobile device, etc.) preferably receives the operating data. The device or an application on the device preferably sends the information, either automatically or upon the receipt of a user input (e.g. the user selects an option to order additional cartridges). The operating data is preferably sent and subsequently, received, when a send event is met, such as when the device determines a need for more power (e.g. more cartridges), when the device places an order for additional cartridges, when the application on the device is active, when the device is coupled to the fuel system, or in response to any other suitable event. Alternatively, the information can be sent periodically (e.g. at a given frequency, such as every day, every week, every month, etc.) or can be sent continuously. In one variation, the information is received from a remote database (e.g. a cloud-based computing platform), wherein the device had sent the information to the database. In a second variation, the information is received directly from the device. The information is preferably transmitted and received wirelessly (e.g. through WiFi, a cellular network, Bluetooth, infrared etc.), but can alternatively be transmitted/received through a wired network or through any other suitable data transmission means.

In a first embodiment, as shown in FIG. 3, the operation data includes an order request generated by each device. The order request is preferably generated in response to a determination of imminent power deficiency by the device. In one variation, the device records the number of cartridges easily accessible to the user (e.g. in the possession of the user), and automatically generates the order request when the number of easily accessible cartridges falls below a threshold number. In a second variation, the device displays an interface that allows the user to order replacement cartridges. In this variation, the device can automatically prompt the user to order replacement cartridges, based on the determined number of cartridges easily accessible to the user.

In a second embodiment, the operation data includes current operation data for each device. Current operation data can be current cartridge information, current fuel cell system operation information, current device operation information, or any other suitable information. Current cartridge information can include the cartridge identifier (e.g. type of cartridge, cartridge rating, etc.), the state of operation of the current cartridge in use, operational parameters of the cartridge (e.g. temperature, pressure, flow rate, etc.), estimated amount of fuel left in the cartridge, estimated amount of fuel storage composition consumed, duration of use, time of use, number of cartridges available to the user, number of cartridges used since the last cartridge shipment was received, or any other suitable cartridge operation parameter. Current fuel cell system operation information can include the fuel cell system status (e.g. operating, purging, inoperative), fuel flow rate into the fuel cell system, efficiency (estimated or measured), power output, operational parameters (e.g. temperature, pressure, humidity), the fuel cell system identifier (e.g. rating, type), duration since the last fuel cell system maintenance, duration of fuel cell system operation, fuel cell system age, fuel cell system error notifications, or any other suitable fuel cell system information. Current device operation information can include the location of the device, the time, the applications running on the device, the auxiliary functions and/or devices the device is running and/or connected to, the state of charge, the device power consumption, operational parameters of the device (e.g. environmental or device temperature, pressure, light, etc.), duration of a charge cycle, a device identifier (e.g. by manufacturer, version, operating system, etc.), or any other suitable device operation information.

In a third embodiment, the operation data includes aggregated information for each device. This information is preferably derived from a plurality of measurements, gathered over a period of time (either stored in the device or on a remote database), wherein the information is processed (e.g. averaged, used for a calculation, etc.) into aggregated information by the device. Aggregated information can include fuel cell system information, fuel cartridge supply information, device information, or any other suitable information. Fuel cell system information can include the age of the fuel cell system (e.g. fuel cells and/or fuel generator), the estimated deterioration of the fuel cell, the estimated lifespan of the fuel cell, average power production over a period of time, power production over a period of time (e.g. as a plurality of data points), temperature over a period of time, fuel flow over a period of time, a list of devices charged with the fuel cell system, or any other suitable parameter of the fuel cell system. Fuel cartridge supply information can include the estimated number of charges left on the current fuel cartridge based on prior use history (e.g. how quickly the device consumes a fuel cartridge), the number of cartridges easily accessible to the user/in user possession, the estimated amount of time before the cartridge supply needs to be replenished (based on prior use history), or any other suitable cartridge supply parameter. Device information can include the device power curve, the device power consumption over a period of time (e.g. a year, a month, a week, a day, an hour, etc.), device power consumption trends (e.g. evening vs. night, seasonal consumption, event-based consumption), fuel cell system use trends, the average, total, or discrete amounts of power drawn from the fuel cell system relative to other power sources (e.g. a wall outlet), the average charge cycle duration and power consumption, a list of discrete charge cycle durations and power consumption amounts, the ratio of device operation directly from fuel cell system power relative to device battery power, a list of the fuel cell systems and/or fuel cartridges that charge the device. Device information can additionally include the average device location over time, trends in location, a list of discrete locations over a period of time (e.g. a list of longitude and latitude), a list of applications and/or auxiliary functions/devices used with the fuel cell system, or any other suitable device usage information.

In a fourth embodiment, the operation data includes future operation data for each device. Future operation data preferably includes the estimated or projected operation data for a second time period later than the first time period, wherein the device preferably performs the estimation but an external device can alternatively perform the estimation. The future operation data can include future cartridge information, future fuel cell system information, and/or future device information. Future cartridge information can include the estimated time of near-complete fuel consumption for the cartridge in use, the estimated time of full consumption of the user's fuel cartridge supply, or any other suitable fuel cartridge information that can be projected. Future fuel cell system information can include the estimated fuel cell operation state, the estimated fuel conversion efficiency, the estimated fuel cell system temperature, or any estimation of other suitable fuel cell system parameters. The estimated fuel conversion efficiency can be determined from the current fuel cell run time, the ages of the fuel cells, the amount of non-fuel matter in the anodes, environmental parameter forecasts, or any other suitable parameter that influences fuel cell efficiency. Environmental parameters can influence fuel cell system operation because the fuel cell system can be a substantially open system. In one example, the fuel cell system efficiency can increase in response to an increase in humidity, particularly when water recycling fuel generation is used. Future device information can include the future location (e.g. as determined from a user account such as a calendar or email, from user habits, etc.), future power requirements, future battery state of charge, or an estimation of any other suitable device parameter. The future power requirements can be determined from historical power usage, from a prediction of application usage, from an environmental forecast, or from any other suitable power consumption-influencing factor. The historical power usage is preferably the history of power consumption for the given device, but can alternatively be the historical average power consumption for devices similar to the given device (e.g. similar operating system, similar device model, similar user type, similar fuel cell system, similar climate, etc.). The future power requirements can be determined from the prediction of application usage and the amount of power each application requires. The prediction of application usage is preferably determined from a history of application use habits for the given device (e.g. the device runs the weather app every day for 10 minutes in the morning), but can be determined from the historical average application use habits or from any other suitable data. The prediction of application usage can additionally include estimating when a specific application will be downloaded to the device and the frequency of use, based on a categorization of the user associated with the device (e.g. early adopter, late follower, heavy gamer, etc.). The future power requirements can be estimated from forecasts of environmental parameters that influence fuel cell system and/or device operation, and can additionally be estimated from historical device use habits correlated with environmental parameter value trends. In one example, a low ambient temperature can influence fuel cell system operation by decreasing the cooling requirement, thereby conserving energy. In another example, the device is historically operated in heat-generation mode when a low ambient temperature is detected, wherein the future power requirement is estimated to be higher than when the temperature is forecast to be higher.

As shown in FIG. 1, determining a future demand parameter from operation data S200 functions to summarize multiple user data points in a manner that describes the projected demand for fuel cartridges, fuel cells, or service. The future demand parameter is preferably calculated from the operation data from a plurality of devices, but can alternatively be calculated from the operation data from one or any number of devices. Alternatively, the future demand parameter can be extrapolated from current sales data, such as from the rate at which cartridges are being purchased. The received operation data can be calculated, mapped, graphed, or otherwise transformed into the future demand parameter. Alternatively, the future demand parameter can include substantially unprocessed operation data. The received operation data is preferably additionally processed and stored, such that historical operation data can be used to predict future demand. The future demand parameter is preferably the future distribution of devices (e.g. across one or more geographic regions, device types, fuel cell types, user types, etc.), but can also be the future fuel cartridge demand for a geographic region, the future fuel cartridge demand for a population, the future fuel cell system demand for a population, the future fuel cell system demand for a geographic region, the future service demand, or any other suitable future demand parameter. Location-based demand is preferably derived from a plurality past users' location data, preferably past device location data but alternatively past fuel cell system use location data. The past user location data is preferably derived from discrete location points, but can alternatively be an average location, a location trend, or any other suitable location information. Time-based demand is preferably derived from past user data. In one example, time-based population data includes peak usage times for the device and/or fuel cell system. In a second example, time-based population data includes device and/or fuel cell system usage trends over the year (e.g. per season, per month). In a third example, time-based population data includes event-based population data (e.g. number of users that attend an event, trend of user population that attend an event). However, any other suitable time-based population data can be derived.

Determining the future distribution of devices preferably includes determining the future geographic distribution of devices, which functions to determine an estimated number of devices within a geographic region at the second time period. However, the future distribution of devices can be the future distribution of devices across different device types, the future distribution of fuel cell systems, or the future distribution of any other suitable device parameter. The geographic region can be an area defined by political borders (e.g. countries, states, districts, etc.), an area within a given distance from a geographic location (e.g. from a distribution center or a manufacturing plant), an area associated with an event, an area defined by a population of users, or any other suitable geographic area. Determining the future distribution of devices preferably includes determining a future location from the operation data and categorizing the devices based on the respective future locations. The future location for a device is preferably a location (e.g. venue, geographic coordinates, location category) with which the device is predicted to be associated (e.g. located within) at a second time period that is later than the first time period. Determining a future location from the operation data can include extracting the future locations from each received order that is associated with the second time period, determining (e.g. calculating, correlating, mapping, etc.) a future location for each device from the respective user settings, determining a future location from the respective device operation history (e.g. from a historical correlation between a location and a time determined from the operation history for the specific device), determining a future location from operation histories of devices having a similar user profile to the given device, determining a future location directly from the received operation data, wherein the operation data includes the future location, or determining a future location in any other suitable manner.

Determining the future fuel cartridge demand for a geographic region preferably includes determining the future geographic distribution of devices and the projected cartridge demand for the devices. The projected cartridge demand for the devices can be determined from the number of fuel cartridge orders placed for the second time period, from a demand trend determined from a plurality of order requests associated with a plurality of time periods and the geographic region, wherein a projected cartridge demand can be extrapolated from the received operation data, from an aggregation of the projected cartridge demand for each individual device as determined from the fuel cartridge demand histories of each individual device (e.g. typically consumes cartridges at a rate of three per month, consumes cartridges twice as quickly when on a business trip, consumes cartridges half as quickly when on vacation, etc.), from the projected cartridge demand for each individual device as determined from the typical operation habits of other devices similar to said device (e.g. similar device type, similar user type, etc.), from the projected cartridge demand for each individual device as determined from the manufacturer specifications, from the projected cartridge demand for each individual fuel cell system as determined from the individual fuel cell system operation history or from manufacturer specifications, from the projected cartridge demand for each individual fuel cell system as determined from the demand histories of fuel cell systems similar to the given fuel cell system, from the individual operation habits of said device in regions having traits similar to the given region (e.g. vacation spot, climate, etc.), from the average operation habits of a device population within the region or similar regions, from the predicted individual fuel supplies of each of said devices, from environmental parameter forecasts for the region that influence fuel cartridge demand or fuel generation efficiency (e.g. temperature, pressure, humidity), from the average operation habits of a device population previously associated with an event that is associated with the second time period and said geographic location (e.g. a recurring event or an event type, such as the Pitchfork concert or a holiday vacation, respectively), or from any other suitable demand-influencing parameter. In one example, the projected cartridge demand as determined from the fuel cartridge demand histories of each individual device is calculated by correlating a parameter indicative of fuel cartridge demand (e.g. power cartridge demand, number of cartridges ordered) with an operation parameter (e.g. time of day, time of year, location, device age, device operating system, etc.), wherein the projected individual device cartridge demand can be selected based on matching the received operation data to the correlated data.

Determining the future fuel cartridge demand for a population of devices, as shown in FIG. 3, can include determining the number fuel cartridge orders received from individual devices of the given device population, determining a demand trend determined from a plurality of order requests associated with the device population, wherein a projected cartridge demand can be extrapolated from operation data, determining the historical fuel cartridge demand for each device within the given device population, the average historical fuel cartridge demand for devices of the given device population, the fuel cartridge demand for the given device population as determined by the manufacturer, and/or determining any other suitable parameter. The device populations for which future fuel cartridge demand can be determined include device types, user types (e.g. heavy energy consumer, light energy consumer, early adopter of technology, late adopter, etc.), or for any other suitable population of devices.

Determining the future fuel cell system demand for a population of devices can include determining the number of fuel cell system orders received from individual devices of the given device population, determining a demand trend determined from a plurality of order requests associated with a plurality of time periods, wherein a projected fuel cell system demand can be extrapolated from the received operation data, determining the historical fuel cell system demand for the given device population as determined from past sales of fuel cell systems to users of the given device population, determining the individual fuel cell system purchase histories for each device within the population, and/or determining any other suitable parameter indicative of historical fuel cell system demand. The device population can be any of the aforementioned device populations mentioned above, or any other suitable device population.

Determining the future fuel cell system demand for a geographic region can include determining from the future geographic distribution of devices and the future fuel cell system demand for the devices within each geographic region. This step can include first categorizing devices into geographic regions, then determining the fuel cell system demand for each region. Alternatively, this step can include first determining the fuel cell system for each device, then categorizing the devices into geographic regions and aggregating the individual fuel cell system demands for each region. The future geographic distribution is preferably determined as described above, but can alternatively be otherwise determined. The future fuel cell system demand is preferably determined as described above, but can alternatively be otherwise determined.

Determining the future service demand functions to determine the predicted service needs for the second time period. The future service demand is preferably the future demand for fuel cell system servicing, but can alternatively be the future demand for device service. The future service demand can be determined for a population of devices, for a geographic region, for a population of fuel cell systems, or for any other suitable population of users. The future service demand can be used to determine when and where to provide service providers, what types of service providers to provide, the number of people that need to be trained to become service providers, or determine any other suitable service-related parameter. The predicted service needs can be determined (e.g. calculated, mapped, graphed, correlated, etc.) from the number of service requests received for the second time period, from a demand trend determined from a plurality of order requests associated with a plurality of time periods, wherein a projected service demand can be extrapolated from the received operation data, from the number of relevant devices or fuel cell systems, from the current parameters of the device or fuel cell system (e.g. operation state, age, amount of degradation, etc.), from the predicted parameters of the device or fuel cell system (e.g. as determined from the individual device or fuel cell system use history or from the use history of a relevant population), from the future location of each device, or from any other suitable parameter indicative of the future service need for the device or fuel cell system.

Determining the future fuel cartridge demand can additionally include accounting for environmental factors, wherein environmental factors can influence the fuel cartridge demand through changes in power requirements and/or operation efficiency. In one variation, the future fuel cartridge demand is increased in response to a decrease in forecast temperature beyond a temperature threshold to account for an increase of users utilizing the device in heat-generation mode. In another variation, the future fuel cartridge demand is decreased in response to an increase in forecast humidity above a humidity threshold to account for an increase in fuel cell system efficiency. However, the future fuel cartridge demand can be otherwise adjusted for environmental parameter forecasts.

Determining the future fuel cartridge demand can additionally include accounting for recurring events. For example, the fuel cartridge demand for a time period and geographic region associated with the Olympic Games can be determined to be higher than a different time period for the same geographic region.

As shown in FIG. 1, determining a supply parameter based on the future fuel cartridge demand S300 functions to determine an actionable parameter for the supplier. This step is preferably performed by the same device that receives the information, but can alternatively be performed by a remote device that receives the future fuel cartridge demand from the first device. The supply chain parameter is preferably a manufacturing parameter, but can alternatively or additionally be a distribution parameter, a service parameter, or any other suitable supply parameter. The supply parameter is preferably determined for fuel cartridge supply, but can alternatively be for fuel cell system supply or device supply.

Determining a manufacturing parameter, as shown in FIG. 3, functions to determine an actionable parameter for a manufacturer. Determining a manufacturing parameter can include determining a target volume and a time period for which the target volume should be manufactured. Determining a manufacturing parameter can additionally include selecting a manufacturing facility, selecting an energy source from which the fuel cartridges are manufactured, or selecting any other suitable manufacturing parameter. The target volume is preferably determined from the future fuel cartridge demand. For example, the target volume for a geographic region is preferably determined from the future fuel cartridge demand for the geographic region. The time period is preferably the second time period for which the future fuel cartridge demand is determined, but can alternatively be the amount of time required for cartridge manufacture or be any other suitable time period. The manufacturing facility is preferably selected based on proximity to the geographic region for which the fuel cartridges are to be supplied, and can additionally be selected based on manufacturing capacity, energy sources available to the facility (e.g. solar, wind, hydrodynamic, energy grid, nuclear, etc.) that are used to manufacture fuel storage composition, lead time (e.g. the time until the target volume can be fulfilled), delivery capabilities (e.g. access to low-carbon-footprint delivery methods, etc.), or any other suitable parameter indicative of the capability of a manufacturing facility to fulfill the target volume. The selected manufacturing facility is preferably the facility capable of providing the target volume of cartridges to the geographic region the fastest, but can alternatively be the manufacturing facility that produces fuel cartridges using only the specified energy sources (e.g. through the user preferences), the manufacturing facility capable of delivering the fuel cartridges in the specified manner (e.g. using low-carbon-footprint methods instead of fossil-fuel burning methods), or any other suitable manufacturing facility. Selecting the energy source from which the fuel cartridges will be manufactured preferably optimizes for the cheapest fuel cartridge manufacturing cost, but can be optimized for the lowest carbon manufacturing cost, or optimized for any other suitable parameter. Multiple manufacturing facilities can be selected, particularly when a single manufacturing facility is incapable of fulfilling the future demand, or when the multiple manufacturing facilities can deliver the desired cartridges faster than a single manufacturing facility. However, a single manufacturing facility can be selected. Selecting the energy source preferably includes weighting the predicted availability of the energy source at the time of manufacture with the cost of manufacturing the fuel cartridge with said energy source, wherein the cheapest energy source (in terms of monetary cost or environmental cost) is preferably selected. The availability of the energy source can be determined from environmental, geological, meteorological, or any other suitable forecast. Determining the manufacturing parameter can additionally include sending the manufacturing parameters to a manufacturing facility. The manufacturing facility to which the manufacturing parameter is sent is preferably the selected manufacturing facility, but can alternatively be a plurality of manufacturing facilities, or to any other suitable manufacturing facility. Determining the manufacturing parameter can additionally include manufacturing the volume of fuel cartridges specified before the second time period, and can additionally include distributing the manufactured cartridges to one or more select distribution centers.

Determining a distribution parameter functions to determine a parameter for short- or long-term distribution. The distribution parameters can be determined for a single device (e.g. to fulfill an order request) or for a population of devices (e.g. an aggregation of order requests, an aggregation of anticipated cartridge demand for a plurality of devices, etc). Determining the distribution parameter preferably includes determining a location, a volume of fuel cartridges, and a time period at which the fuel cartridges should be at said location. Determining the distribution parameter can additionally include selecting a distribution channel (e.g. shipped, brick and mortar), selecting a distribution facility, or include selecting any other suitable distribution parameter. The location, volume of fuel cartridges, and time period are preferably determined from the future demand parameter, but can be otherwise determined. The distribution channel is preferably selected based on user preferences (e.g. wherein the user preferences specify a preferred distribution channel), speed of accessibility to the user, or based on any other suitable parameter. The selected distribution channel can be promoted to the user by offering a promotion, offering a suggestion, or through any other suitable means. The distribution facility is preferably selected based on proximity to the one or more delivery locations (e.g. within 3 mi, within a 2 day delivery radius, within walking distance, within the delivery zone of the distribution facility, etc.), based on the current facility inventory, the predicted facility inventory, the distribution means available to the facility, the environmental forecast for the facility region, the fulfillment capabilities of the facility, and/or any other suitable distribution facility parameter. The distribution parameters are preferably selected to optimize for speed of cartridge availability to the user, but can alternatively be selected to optimize for user preferences (e.g. selected based on available delivery methods, wherein the user preferences for the device to which the cartridges are to be delivered specify a delivery method), to optimize for the order request, or be selected to optimize for any other suitable parameter. In one variation, the constituent orders forming the future cartridge demand are prioritized based on the respective future location proximity to the distribution facility, the inventory for the distribution facility, and/or the need for the cartridge (e.g. how low the device cartridge inventory is). Determining the distribution parameter can additionally include sending the distribution parameters to a distribution center, or can include the step of directing the user to the distribution center (e.g. by presenting an address, map, or directions on the device). The latter variation can additionally include the step of promoting a low-carbon footprint transportation method, such as walking or public transit, by providing an incentive to the user (e.g. cash incentive, coupon, free public transit ticket, etc.). Determination that the user utilized the low-carbon-footprint transportation method can be determined by receiving information from the device accelerometer, pedometer, ticket application, or by any other suitable method. Determining the distribution parameter can additionally include distributing the fuel cartridges to a geographic location associated with the future locations of the devices. In one example, the estimated number of fuel cartridges for a device can be automatically delivered to a hotel that the device is predicted to be located in (e.g. as determined from calendar information), prior to user arrival at the hotel.

Determining a service parameter functions to determine a parameter for short- or long-term service needs. The service parameters can be determined for a single device (e.g. to fulfill an order request) or for a population of devices (e.g. an aggregation of order requests, an aggregation of anticipated cartridge demand for a plurality of devices, etc). Determining the service parameter preferably includes determining a service location, a volume of service events, and a time period at which the servicing will be required. Determining the service parameter can additionally include selecting a service method (e.g. online, in-person, etc), selecting a service facility to which service personnel should be provided, selecting a service type (e.g. fuel cell service, fuel cartridge service, regular maintenance, specialized maintenance, etc.), selecting a service provider training program, selecting a target number of service providers to be trained by the second time period, or include selecting any other suitable service parameter. The location, volume of fuel cartridges, and time period are preferably determined from the future service demand parameter, but can be otherwise determined. The service method is preferably selected based on user preferences (e.g. wherein the user preferences specify a preferred service channel), speed of accessibility to the user, or based on any other suitable parameter. The selected service channel can be promoted to the user by offering a promotion, offering a suggestion, or through any other suitable means. The service facility is preferably selected based on proximity to the one or more future locations (e.g. within 3 mi, within a 2 day delivery radius, within walking distance, within the delivery zone of the service facility, etc.), based on the current number of available service providers at the facility, the predicted number of available service providers at the facility, the service types available at the facility, the environmental forecast for the facility region, and/or any other suitable service facility parameter. The selected service facility can be promoted to the user through an advertisement, a default selection (e.g. assignment to the facility), as the first facility option in a list of service facilities available to the user, or in any other suitable manner. The service type, training program, and target number of service providers are preferably determined from the anticipated type of service, the anticipated number of service providers for each service type that will be needed to meet the future service demand, and the current number of service providers for each service type. However, these parameters can be otherwise determined. The service parameters are preferably selected to optimize for speed of service provision to the user, but can alternatively be selected to optimize for user preferences, to optimize for service availability to a population of users, to optimize for an order request, or be selected to optimize for any other suitable parameter. In one variation, the constituent orders forming the future service demand are prioritized based on the respective future location proximity to the service facility, the number of available service providers for the service facility, and/or the need for the service (e.g. how much longer the fuel cell system or device can operate without servicing). Determining the service parameter can additionally include sending the service parameters to a service center (e.g. making an appointment for the device), or can include directing the user to the service center (e.g. by presenting an address, map, or directions on the device). The latter variation can additionally include the step of promoting a low-carbon footprint transportation method, such as walking or public transit, by providing an incentive to the user (e.g. cash incentive, coupon, free public transit ticket, etc.). Determination that the user utilized the low-carbon-footprint transportation method can be determined by receiving information from the device accelerometer, pedometer, ticket application, or by any other suitable method.

Determining a supply parameter can additionally include determining a sales prediction. The sales prediction is preferably derived from the aggregate number of order requests received, but can be derived from the number of users with cartridge supplies near or under the predetermined threshold, from the number of users with cartridges operating at close to complete consumption, or from any other suitable parameter. The sales prediction preferably serves as a measurement for cartridge demand. The sales prediction can be an overall prediction, for a geographic region and/or for a given time period (e.g. one financial quarter).

Determining a supply parameter can additionally include determining a product development parameter, wherein the aggregated user data is used to optimize the fuel cartridge and/or fuel cell system for a given population of users. The data used preferably includes location data, device data, power per charge data, auxiliary function use data, auxiliary application use data, a combination of the above, or any other suitable piece of data. The product development parameter can include cartridge size, number of charges per cartridge, mechanical properties of the fuel cell system and/or cartridge, portability of the fuel cell system and/or cartridge, fuel cell system auxiliary features (e.g. external heater, light, etc.), or any other suitable product development parameter. The product development parameter can be used to develop device-optimized cartridges (e.g. each cartridge is completely consumed at the end of exactly N number of device charge cycles), activity-optimized fuel cell systems (e.g. aggregated user data indicates that many users use fuel cell systems to charge their devices when in the forest or on the mountain, indicative of users using fuel cell systems when camping, hiking, or snowboarding—thus, a version of the fuel cell system can be optimized for rugged environments), habit-optimized fuel cell systems (e.g. a population of users only charge their devices at home, so a larger fuel cell system/fuel cartridge can be developed, while a second population of users charge their devices while travelling, so a more portable fuel cell system/fuel cartridge can be developed), or any other optimized fuel cell and/or fuel cartridge.

Determining a supply parameter can additionally include determining a service parameter that functions to determine the adequate amount of resources required to adequately service users during a time period or at a location. For example, the number of customer service representatives can be adjusted based on the predicted number of user service requests (e.g. based on historical user service request data, the current number of degraded fuel cell systems, the current number of nearly empty fuel cartridges, etc.). In another example, the number of technicians stationed to a service location (that a user can take their system to be repaired or maintained) can be dynamically adjusted based on the predicted number of user service requests.

Determining a supply parameter can additionally include determining potential promotion partners and/or acquisition targets based on the future demand parameter and/or the operation data. These companies are preferably determined from data describing application and/or auxiliary function/device usage with the fuel cell system/fuel cartridge. In a first example, a potential promotion partner can be an application that is determined to be commonly used (e.g. across the user population) with the fuel cell system. In a second example, a potential acquisition target can be an auxiliary device manufacturer, wherein the auxiliary device is commonly used with the fuel cell system by the user population.

Determining a supply parameter can additionally include determining a product promotion campaign from the future demand parameter. Since the suppliers know the times and locations of high and low cartridge demand, the suppliers can plan more effective product promotion campaigns. In one example, a supplier provides a coupon for fuel cartridges to the attendees of an event (e.g. at the event), wherein the coupon can be presented on the users' devices. In a second example, a supplier can target a specific user population that, based on the aggregated data, favor fuel cell system usage over other forms of power (e.g. a supplier creates a marketing campaign specifically targeting Apple users).

The method can additionally include processing the aggregated operation data into a user recommendation. The user recommendation is preferably derived from the actions of similar users within the user population, but can be derived solely from the given user's history.

In a first variation, the user recommendation is a product recommendation. The product recommendation is preferably for a fuel cell system, but can alternatively be for a fuel cartridge. In a first example, the recommendation is derived from the frequency that the user is in a location (e.g. the user is oftentimes in uninhabited places such as the woods, so a light, rugged, camping fuel cell system is recommended). In a second example, the recommendation is based off of the user-preferred use case (e.g. the device is typically stationary and at home during fuel cell system use, as determined by the accelerometer and GPS, so a larger, stationary fuel cell system is recommended; the device is typically moving during fuel cell system use as determined by the accelerometer and GPS, so a smaller, mobile fuel cell system is recommended). In a third example, the recommendation is based off the environment and/or location (e.g. temperature sensors indicate a low-temperature ambient environment, so a fuel cell system that radiates waste heat and functions as a heater is recommended).

In a second variation, the user recommendation is a user-targeted product promotion. In one example, a deal for replacement cartridges is presented to the user (e.g. on the device) when the user cartridge supply is low. In a second example, a deal for advance purchase of replacement cartridges is presented to the user (e.g. on the device) based on a user history of attending an event with a history of high attendance (e.g. to alleviate the strain on the suppliers at the event).

In a third variation, the user recommendation is a maintenance or repair recommendation. In one example, the fuel cell system of the user is deemed in need of maintenance or repair (e.g. based on power production, time elapsed since the last fuel cell system checkup, etc.), wherein the recommendation for a repair and/or maintenance session is presented to the user on the device. The device can additionally present the service locations nearest the user, service locations in a user-defined geographic area, service times available, or any other suitable information. The device can additionally send a reservation request to a service center for a service appointment.

As a person skilled in the art will recognize from the previous detailed description and from the figures and claims, modifications and changes can be made to the preferred embodiments of the invention without departing from the scope of this invention defined in the following claims.

We claim:

1. A method for controlling hydrogen cartridge supply for a device powered by a fuel cell system, the fuel cell system including a fuel cell stack that converts hydrogen from the hydrogen cartridge into electrical power, the method comprising:
receiving device operation data from each of a plurality of devices;
categorizing the device operation data into geographic regions according to respective location data determined from the respective operation data;
calculating a future hydrogen cartridge demand for each geographic region from the device operation data associated with the geographic region;
calculating a target hydrogen cartridge manufacturing volume for each geographic region from the respective future hydrogen cartridge demand;
selecting a hydrogen cartridge manufacturing facility for each geographic region based on the respective target hydrogen cartridge manufacturing volume and a proximity of the hydrogen cartridge manufacturing facility to the geographic region; and
sending the respective target hydrogen cartridge manufacturing volume to each selected hydrogen cartridge manufacturing facility.

2. The method of claim 1, wherein calculating the future hydrogen cartridge demand for each geographic region further comprises calculating the future fuel cartridge demand for each geographic region based on a forecast of an environmental parameter associated with the geographic region.

3. The method of claim 3, wherein the forecast environmental parameter comprises a humidity forecast, wherein calculating the future hydrogen cartridge demand comprises decreasing the calculated hydrogen cartridge demand when the humidity forecast is below a humidity threshold.

4. The method of claim 1, wherein selecting the hydrogen cartridge manufacturing facility for each geographic region is further based on a projected availability of a primary energy source used to generate hydrogen at the hydrogen cartridge manufacturing facility.

5. The method of claim 4, wherein the primary energy source comprises wind, wherein the hydrogen cartridge manufacturing facilities are selected based on wind forecasts.

6. A method for controlling fuel cartridge supply for a device powered by a fuel cell system, the fuel cell system including a fuel cell stack that converts fuel from the fuel cartridge into electrical power, the method comprising:
receiving operation data from each of a plurality of devices at a first time period;
calculating a future fuel cartridge demand from the operation data, the future fuel cartridge demand associated with a second time period after the first time period;
calculating a target fuel cartridge manufacturing volume from the future hydrogen cartridge demand; and
sending the target fuel cartridge manufacturing volume to a manufacturing facility.

7. The method of claim 6, wherein the operation data comprises location data, the method further comprising categorizing the operation data into geographic regions based on the location data associated with the respective devices.

8. The method of claim 7, further comprising determining a future location for each of the plurality of devices from the respective location data, wherein the future location comprises a location with which the device will be associated during the second time period.

9. The method of claim 8, wherein the future location for a device is determined from the operation data previously received from the device.

10. The method of claim 8, wherein the location data comprises the future location, such that the future location is received from the device.

11. The method of claim 10, wherein the future location comprises a location derived from a calendar accessible to the device, wherein the future location is associated with the second time period on the calendar.

12. The method of claim 7, wherein calculating the future fuel cartridge demand comprises calculating a future fuel cartridge demand for each geographic region based on the operation data categorized to the geographic region.

13. The method of claim 12, further comprising selecting a distribution channel for a geographic region from a plurality of distribution channels associated with the geographic region, wherein the distribution channel is selected based on the future fuel cartridge demand for the geographic region.

14. The method of claim 13, wherein the distribution channel is further selected based on a proximity of the distribution channel to the future locations of the devices.

15. The method of claim 12, wherein the future fuel cartridge demand for each geographic region is further based on an environmental parameter forecast for the geographic region for the second time period.

16. The method of claim 15, wherein calculating the future fuel cartridge demand for a geographic region comprises increasing the future fuel cartridge demand when a temperature forecast for the geographic region for the second time period decreases below a predetermined temperature threshold.

17. The method of claim 12, wherein calculating the target fuel cartridge manufacturing volume comprises calculating the target fuel cartridge manufacturing volume for each geographic region.

18. The method of claim 17, wherein sending the target fuel cartridge manufacturing volume to a manufacturing facility comprises sending the target fuel cartridge manufacturing volume for a geographic region to a manufacturing facility associated with the geographic region.

19. The method of claim 6, wherein calculating the future fuel cartridge demand is further based on operation data previously received from the device.

20. The method of claim 6, further comprising selecting a manufacturing facility from a plurality of manufacturing facilities, wherein calculating the target fuel cartridge manufacturing volume comprises calculating the target fuel cartridge manufacturing volume for the selected facility, wherein sending the target fuel cartridge manufacturing volume comprises sending the target fuel cartridge manufacturing volume to the selected facility.

21. The method of claim 20, wherein the manufacturing facility is selected based on an availability of an energy source at the facility.

22. The method of claim 21, wherein the energy source comprises a renewable energy source.

23. The method of claim 21, further comprising determining a preferred energy source associated with each device, wherein the manufacturing facility is selected based on an availability of the preferred energy source at the facility.

24. The method of claim 23, wherein the preferred energy source associated with each device is determined from a set of user preferences associated with said device.

25. The method of claim 20, wherein the manufacturing facility is selected based on a manufacturing capability of the facility.

26. The method of claim 6, further comprising manufacturing fuel cartridges to satisfy the target fuel cartridge manufacturing volume before the second time period.
